(19) United States
(12) Patent Application Publication
(10) Pub. No.: US 2026/0054783 A1
(43) Pub. Date: Feb. 26, 2026

(54) MULTI-MODE ACTUATION MECHANISM

(71) Applicant: Deere & Company, Moline, IL (US)

(72) Inventors: SATYAMU RAVUTHU, PUNE (IN); SAURABH GUPTA, PUNE (IN); Pratul Vishwakarma, PUNE (IN); SAMEET KAVATHE, PUNE (IN); NISHANT SHAH, PUNE (IN)

(21) Appl. No.: 19/250,532

(22) Filed: Jun. 26, 2025

(30) Foreign Application Priority Data
Aug. 20, 2024 (IN) 202421062706

(51) Int. Cl. B62D 49/06

(52) U.S. Cl. CPC B62D 49/0692

(57) ABSTRACT

A multi-mode actuation mechanism for operating a system in various modes includes a lever having a pivot point and a connecting point, the pivot point and the connecting point being spaced apart, a cable connecting the lever to the system via the connecting point of the lever, a plunger displaceable between an extended position and a retracted position, the plunger being biased to the extended position, a groove defined on the plunger, a locking pin displaceable between a locked position and an unlocked position, the locking pin being disposed within the groove in the locked position, the locking pin being substantially perpendicular to the plunger, and the locking pin being biased to the locked position, a casing partially encasing the plunger, and a stopper restricting displacement of the plunger between a plurality of desired position corresponding a required parameter of the system.

### CROSS-REFERENCE TO RELATED APPLICATIONS

This application claims priority to India Patent Application No. 202421062706, filed Aug. 20, 2024, which is hereby incorporated by reference.

### FIELD OF THE DISCLOSURE

The disclosure relates to the field of actuating a system between a plurality of modes, corresponding to the requirement of the system.

### BACKGROUND

There are several systems where there is a requirement to operate between multiple modes. One such system is a radiator fan. Currently, radiator fan can be operable between multiple modes as mentioned in IN202121012778 and IN202421027811.

### SUMMARY

According to an aspect of the present disclosure, a multi-mode actuation mechanism for operating a system in various modes includes a lever having a pivot point and a connecting point, the pivot point and the connecting point being spaced apart, a cable connecting the lever to the system via the connecting point of the lever, a plunger displaceable between an extended position and a retracted position, the plunger being biased to the extended position, a groove defined on the plunger, a locking pin displaceable between a locked position and an unlocked position, the locking pin being disposed within the groove in the locked position, the locking pin being substantially perpendicular to the plunger, and the locking pin being biased to the locked position, a casing partially encasing the plunger, and a stopper restricting displacement of the plunger between a plurality of desired position corresponding a required parameter of the system.

According to an aspect of the present disclosure, the lever is pivotable about the pivot point.

According to an aspect of the present disclosure, the connecting point is angularly rotatable about the pivot point.

According to an aspect of the present disclosure, the locking pin is disposed within a housing, the housing being perpendicular to the casing.

According to an aspect of the present disclosure, the locking pin is actuated by at least one of a manual operation, a hydraulic operation, a pneumatic operation, an electric operation, and an electro-mechanical operation.

According to an aspect of the present disclosure, the plunger and the locking pin are biased by an associated resilient member, the resilient member being a compression spring.

According to an aspect of the present disclosure, the stopper has an extension projecting from the lever and a projection being configured to selectively restrict the extension corresponding the required parameter of the system.

According to an aspect of the present disclosure, the required parameter is at least one mode of operation of the system.

According to an aspect of the present disclosure, the system includes a radiator fan.

According to an aspect of the present disclosure, the at least one mode of operation of the radiator fan includes a full cooling mode, a cleaning mode, and an economical mode when the lever is in the cooling position, the cleaning position, and the eco-position, respectively.

According to an aspect of the present disclosure, a tractor includes the multi-mode actuation mechanism.

The above and other features will become apparent from the following detailed description and accompanying drawings.

### BRIEF DESCRIPTION OF THE DRAWINGS

The present disclosure will now be described with respect to the accompanying drawings:

FIG. 1 illustrates a tractor with a cut-out of a hood of the tractor, indicating elements under the hood;

FIG. 2 illustrates the multi-mode actuation mechanism, in accordance with the present disclosure;

FIG. 3 particularly illustrates a locking mechanism, in accordance with the present disclosure, as illustrated in FIG. 2;

FIG. 4 to FIG. 6 illustrate the locking mechanism, in accordance with the present disclosure, in multiple modes of operation; and

FIG. 7 to FIG. 9 illustrate a fan blade of the reversible radiator fan assembly in a plurality of configuration.

### DETAILED DESCRIPTION

The embodiments or implementations disclosed in the above drawings and the following detailed description are not intended to be exhaustive or to limit the present disclosure to these embodiments or implementations.

Particularly, in the off-road vehicles, it has become important for the radiator fan to perform more than just the function of cooling. The breadth of the modes of radiator fan ranges from the conventional function of cooling to the cleaning of the grill of the hood to enable free flow. This helps in achieving better fuel efficiency across varied geographies by considering duty cycle and engine load usage. However, there is felt a need for mechanism for actuation of the radiator fan between the different modes, based on requirement.

The present disclosure envisages achieving at least one of the following objects, thereby overcoming the drawbacks of prior art:

An object of the present disclosure is to provide a mechanism capable of enabling a system to operate between multiple modes.

Another object of the present disclosure is to provide a mechanism capable of enabling reduction of emission as a result of optimum operation of the system.

Yet another object of the present disclosure is to provide a mechanism which improves fuel efficiency of the system.

Other objects of the present disclosure will be apparent when the description of the disclosure is read in conjunction with the accompanying drawings. The accompanying drawings provided herein are merely illustrative and does not intend to limit the scope and ambit of the present disclosure.

In accordance with the present disclosure there is provided a multi-mode actuation mechanism for operating a system in various modes. The multi-mode actuation mechanism includes a lever, a plunger encased within a casing and operable by the lever, a locking pin and stopper. The casing partially encases the plunger. The plunger is defined by a groove.

The lever has a pivot point and a connecting point. The lever is pivotable about the pivot point. The pivot point and the connecting point is spaced apart. The connecting point is angularly rotatable about the pivot point. A cable connects the lever to the system via the connecting point of the lever. The plunger displaceable between an extended position and a retracted position. The plunger is biased to the extended position.

The locking pin is displaceable between a locked position and an unlocked position. The locking pin is disposed within the groove in the locked position. The locking pin is substantially perpendicular to the plunger. The locking pin is biased to the locked position. The locking pin is disposed within a housing. The housing is perpendicular to the casing. The locking pin is actuated by a manual operation, a hydraulic operation, a pneumatic operation, an electric operation, and an electro-mechanical operation. The plunger and the locking pin are biased by an associated resilient member. The resilient member is a compression spring.

The stopper restricts displacement of the plunger between a plurality of desired position corresponding a required parameter of the system. The stopper has an extension projecting from the lever and a projection. The projection is configured to selectively restrict the extension, corresponding the required parameter of the system. The required parameter is at least one mode of operation of the system.

Various features, aspects, and advantages of the present disclosure will be apparent from the following detailed description of the disclosure when read in conjunction with the accompanying drawings wherein like numerals represent like components.

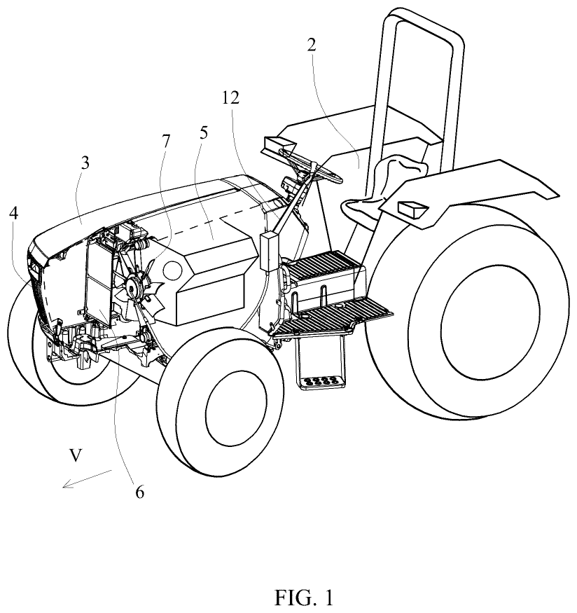

FIG. 1 illustrates a tractor (1) having an operator station (2) and a hood (3), specifically illustrating a cross-section of the hood (3) with a grill (4). The cross-section of the hood (3) illustrating major components located under the hood (3) of the tractor (1), such as, an engine (5), a radiator (6) and a radiator fan (7). The radiator fan (7) has a plurality of fan blade (8). The tractor (1) traverses in a forward direction V. Hereinafter, all indicated directions and location of the tractor (1) and all associated components thereof, such as, forward, backward, rear, front, up, above, below, down, up, left and right shall refer to the direction of forward motion V of the tractor (1).

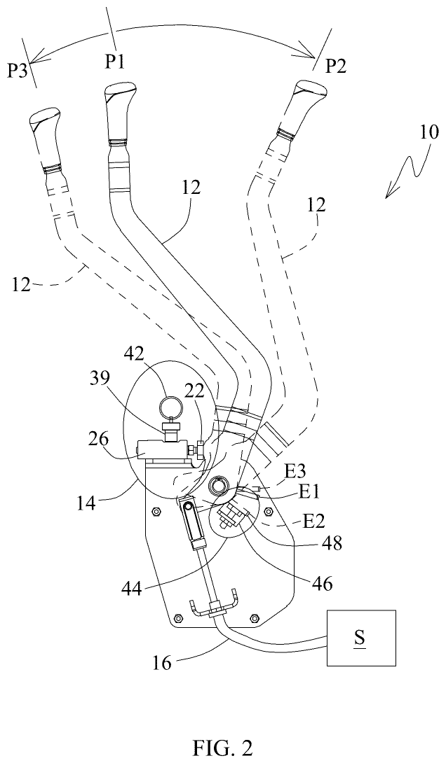

Referring to FIG. 2, a multi-mode actuation mechanism (10) is illustrated, as being connected to a system (S). For the purpose of explanation of the present disclosure, the system (S) will be considered as the radiator fan (7), shown in FIG. 1. The multi-mode actuation mechanism (10) includes a lever (12) and a locking arrangement (14). Although the present disclosure of the multi-mode actuation mechanism (10) will be described with reference to the radiator fan (7), however, a person skilled in the art will appreciate that the present disclosure may be used in any system which is required to be operated in multiple modes. The disclosure of the radiator fan as discussed in related co-pending applications IN202121012778 and IN202421027811 is included by way of reference.

The lever (12) is displaceable between a cooling position (P1), a cleaning position (P2), and an eco-position (P3) based on requirement. The lever (12) is held in the required position by the locking arrangement (14), as illustrated in FIG. 2. A cable (16) connects the multi-mode actuation mechanism (10) to the system (S), such as, radiator fan (7). The radiator fan (7) is operable in a full cooling mode, a cleaning mode, and an economical mode when the lever (12) is respectively in the cooling position (P1), the cleaning position (P2), and the eco-position (P3). The lever (12) has a pivot point (18) and a connecting point (20). The pivot point (18) and the connecting point (20) are spaced apart. The cable (16) is connected to the lever (12) via the connecting point (20) of the lever (12). The lever (12) is pivotable about the pivot point (18). The connecting point (20) is angularly rotatable about the pivot point (18).

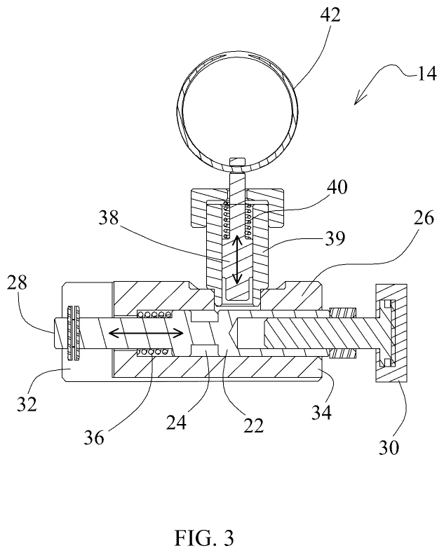

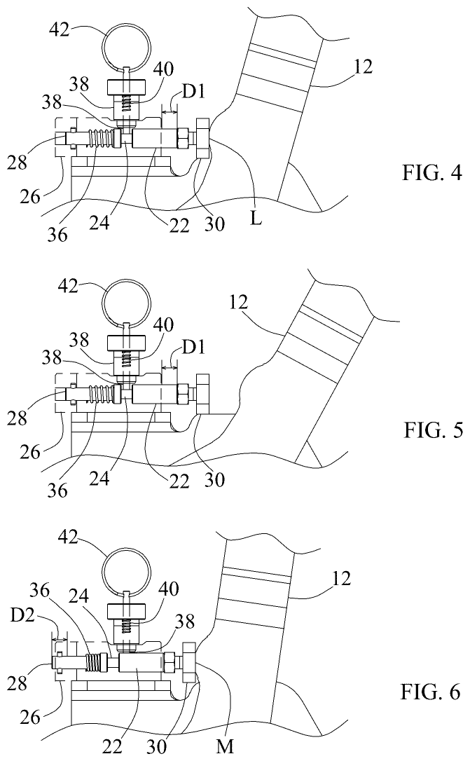

Now particularly referring to FIG. 3, the locking arrangement (14) includes a plunger (22) defined by a groove (24). The groove (24) is substantially perpendicular to the axis of the plunger (22). The plunger (22) is partially disposed within a casing (26). The plunger (22) has an enclosed end (28) and an operational end (30). The casing (26) has a first end (32) and a second end (34). The enclosed end (28) of the plunger (22) is proximate to the first end (32) while the operational end (30) is proximate to the second end (34). The enclosed end (28) is disposed within the casing (26) while the operational end (30) is disposed outside the casing (26). The plunger (22) is displaceable between a first position and a second position. The plunger (22) is displaceable by a distance (D1), as indicated in FIG. 4 and FIG. 5. The plunger (22) is in the first position in FIG. 4 and FIG. 5. The plunger (22) is displaceable to a second position, as illustrated in FIG. 6, such that, the enclosed end (28) is displaced by a distance (D2). The distance (D2) is equal to the distance (D1). The plunger (22) is biased to the first position by a first spring (36) disposed within the casing (26), proximate to the first end (32). The first spring (36) is a compression spring. The first spring (36) is in expanded configuration within the casing (26) in the first position. The first spring (36) is in contracted configuration in the second position within the casing (26).

The locking arrangement (14) also includes a locking pin (38). The locking pin (38) is disposed substantially perpendicular to the plunger (22). The locking pin (38) is disposed within a housing (39). The housing (39) is perpendicular to the casing (26).

The locking pin (38) is displaceable between a locked position and an unlocked position. In the locked position, the locking pin (38) is disposed within the groove (24). When the lever (12) is in the cooling position (P1) and cleaning position (P2), the locking pin (38) is positioned in the groove (24) to enable the locked position. The locking pin (38) is biased to the locked position, by a second spring (40). The locking pin (38) is actuated by a manual operation, a hydraulic operation, a pneumatic operation, an electric operation, or an electro-mechanical operation.

FIG. 2 to FIG. 6 illustrates a locking pin (38) which is manually operated by lifting using a ring (42). The second spring (40) is in expanded configuration in the locked position. The second spring (40) is in contracted configuration in the unlocked position. When the plunger (22) is in first position, the locking pin (38) is in locked position. When the plunger (22) is in second position, the locking pin (38) is in unlocked position.

Further, the multi-mode actuation mechanism (10) has a stopper (44). The stopper (44) limits displacement of the lever (12) beyond the cleaning position (P2). The stopper (44) includes an extension (46) and a projection (48). The extension (46) is displaceable between E1, E2 and E3 positions, particularly indicated in FIG. 2, corresponding to the cooling position (P1), the cleaning position (P2), and the eco-position (P3), respectively. The extension (46) contacts the projection (48), to be in position (E2) to limit movement beyond the cleaning position (P2) of the lever (12). The extension (46) is in the positions E1 and E2 respectively corresponding to the cooling position (P1) and the eco-position (P3), respectively, of the lever (12).

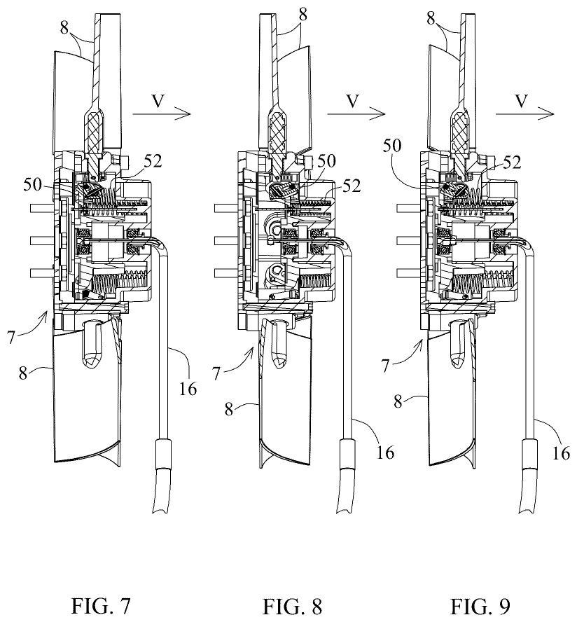

Now, operation of the multi-mode actuation mechanism (10) will be discussed with reference to FIG. 2 to FIG. 9. During normal operation, the lever (12) is in the cooling position (P1), as illustrated in FIG. 2, and the plunger (22) and the locking pin (38) is in first position, as shown in FIG. 4. The locking pin (38) is disposed within the groove (24) and the first spring (36) is in expanded configuration while the second spring (36) is also in expanded configuration. Also, the lever (12) is in contact with the plunger (22) at the point (L), indicated in FIG. 4. The fan blades (8) are positioned so as to achieve full cooling of the engine. The fan blades (8) can subtend an angle in the range of +35 degree to +45 degree, as illustrated on FIG. 7.

In case of choking of the grill (4) of the tractor, the lever (12) is displaced to the cleaning position (P2), as illustrated in FIG. 2, until the extension (46) contacts the projection (48) and is in the position (E2). The position of the plunger (22) and the locking pin (38) are as illustrated in FIG. 5. This causes the radiator fan (7) to be reversed as discussed in IN202121012778. As illustrated in FIG. 8, operation of the cable (16) causes the shifter (50) to be linearly displaced within an enclosure (not particularly indicated) of the radiator fan (7) and against the resilience force of the springs (52). This eventually causes movement of the fan blades (8) to the cleaning configuration resulting in the air under the hood (3) to be blown towards the radiator (6). The fan blades (8) can subtend an angle in the range of −35 degree to −45 degree. The air under the hood (3) passes through the radiator (6) and facilitates in loosening and displacing the dirt and chaff from the grill (4) and the radiator (6). This results in cleaning the grill (4) and the radiator (6). The lever (12) is maintained in the cleaning position (P2) by the operator.

Again, when the fan blades (8) are required to be in economy mode, the lever (12) is displaced to the eco-position (P3). To achieve the eco-position (P3) of the lever (12), as shown in FIG. 2, the locking pin (38) is lifted to disengage the locking pin (38) from the groove (24), as shown in FIG. 6. At this position of the locking pin (38), the second spring (40) is compressed. The lever (12) pushes the plunger (22) at the point (M). FIG. 9 illustrates the position of the fan blade (8) in the eco-position (P3) of the lever (12). In the eco-position (P3), the fan blades (8) results in cooling with 65% less power consumption with 45% of airflow compared to the cooling mode. The lever (12) is in the eco-position (P3) during operation such as haulage operation or any other low power consumption application. The lever (12) is maintained in the eco-position (P3), by operation of the spring (52).

According to some embodiments, the multi-mode actuation mechanism (10) of the present disclosure helps in providing multiple mode of operation of the system (S) by utilizing simple configuration. Additionally, according to some embodiments, the multi-mode actuation mechanism (10) helps reducing the daily operating cost by 2% to 4% while ensuring better fuel efficiency.

### Technical Advancement

According to some embodiments, the present disclosure has several technical advancements including, but not limited to, the realization of:
a system operating in multiple modes;
2% to 4 % reduction in daily operating cost of the system.

While the foregoing specification has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure which comes within known or customary practice in the art to which this disclosure pertains.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

Unless otherwise limited or modified, lists with elements that are separated by conjunctive terms (for example, “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A multi-mode actuation mechanism for operating a system in various modes, comprising:
a lever having a pivot point and a connecting point, the pivot point and the connecting point being spaced apart;
a cable connecting the lever to the system via the connecting point of the lever;
a plunger displaceable between an extended position and a retracted position, the plunger being biased to the extended position;
a groove defined on the plunger;
a locking pin displaceable between a locked position and an unlocked position, the locking pin being disposed within the groove in the locked position, the locking pin being substantially perpendicular to the plunger, and the locking pin being biased to the locked position;
a casing partially encasing the plunger; and
a stopper restricting displacement of the plunger between a plurality of desired position corresponding a required parameter of the system.

2. The mechanism of claim 1, wherein the lever is pivotable about the pivot point.

3. The mechanism of claim 1, wherein the connecting point is angularly rotatable about the pivot point.

4. The mechanism of claim 1, wherein the locking pin is disposed within a housing, the housing being perpendicular to the casing.

5. The mechanism of claim 1, wherein the locking pin is actuated by at least one of a manual operation, a hydraulic operation, a pneumatic operation, an electric operation, and an electro-mechanical operation.

6. The mechanism of claim 1, wherein the plunger and the locking pin are biased by an associated resilient member, the resilient member being a compression spring.

7. The mechanism of claim 1, wherein the stopper has an extension projecting from the lever and a projection being configured to selectively restrict the extension corresponding the required parameter of the system.

8. The mechanism of claim 1, wherein the required parameter is at least one mode of operation of the system.

9. The mechanism of claim 8, wherein the system includes a radiator fan.

10. The mechanism of claim 9, wherein the at least one mode of operation of the radiator fan includes a full cooling mode, a cleaning mode, and an economical mode when the lever is in the cooling position, the cleaning position, and the eco-position, respectively.

11. A tractor including a multi-mode actuation mechanism for operating a system in various modes, comprising:
a radiator fan;
a lever having a pivot point and a connecting point, the pivot point and the connecting point being spaced apart;
a cable connecting the lever to the system via the connecting point of the lever;
a plunger displaceable between an extended position and a retracted position, the plunger being biased to the extended position;
a groove defined on the plunger;
a locking pin displaceable between a locked position and an unlocked position, the locking pin being disposed within the groove in the locked position, the locking pin being substantially perpendicular to the plunger, and the locking pin being biased to the locked position;
a casing partially encasing the plunger; and
a stopper restricting displacement of the plunger between a plurality of desired position corresponding a required parameter of the system.

12. The tractor of claim 11, wherein the lever is pivotable about the pivot point.

13. The tractor of claim 11, wherein the connecting point is angularly rotatable about the pivot point.

14. The tractor of claim 11, wherein the locking pin is disposed within a housing, the housing being perpendicular to the casing.

15. The tractor of claim 11, wherein the locking pin is actuated by at least one of a manual operation, a hydraulic operation, a pneumatic operation, an electric operation, and an electro-mechanical operation.

16. The tractor of claim 11, wherein the plunger and the locking pin are biased by an associated resilient member, the resilient member being a compression spring.

17. The tractor of claim 11, wherein the stopper has an extension projecting from the lever and a projection being configured to selectively restrict the extension corresponding the required parameter of the system.

18. The tractor of claim 11, wherein the required parameter is at least one mode of operation of the system.

19. The tractor of claim 18, wherein the system includes the radiator fan.

20. The tractor of claim 19, wherein the at least one mode of operation of the radiator fan includes a full cooling mode, a cleaning mode, and an economical mode when the lever is respectively in the cooling position, the cleaning position, and the eco-position.
